(19) United States
(12) Patent Application Publication
(10) Pub. No.: US 2024/0394466 A1
(43) Pub. Date: Nov. 28, 2024

(54) DOCUMENT MASKING DEVICE, DOCUMENT MASKING METHOD, AND PROGRAM STORAGE MEDIUM

(71) Applicant: NEC Corporation, Minato-ku, Tokyo (JP)

(72) Inventor: Yasuo IIMURA, Tokyo (JP)

(73) Assignee: NEC Corporation, Minato-ku, Tokyo (JP)

(21) Appl. No.: 18/694,542

(22) PCT Filed: Jan. 7, 2022
(86) PCT No.: PCT/JP2022/000317

§ 371 Date: Mar. 22, 2024

(30) Foreign Application Priority Data
Oct. 28, 2021 (JP) 2021-176073

(51) Int. Cl. G06F 40/151; G06F 21/62; G06F 40/216; G06V 30/10; G06V 30/414

(52) U.S. Cl. CPC G06F 40/151; G06F 21/6245; G06F 40/216; G06V 30/10; G06V 30/414

(57) ABSTRACT

This document masking device includes an extraction unit, a presentation unit, and an output unit so as to be able to flexibly respond to changing a word to be masked, and make a masking process performed on a document efficient while suppressing an increase in the load on a device. The extraction unit extracts, from text data of a document, words which belong to the attribute to be concealed that indicates the kinds of words to be masked by using natural language processing techniques. The presentation unit presents the extracted words as masking candidates. The output unit outputs a document in which words to be masked, designated as a masking target among the masking candidates, are masked.

### TECHNICAL FIELD

The present invention relates to a technique for generating a document in which a portion of a concealment target is masked.

### BACKGROUND ART

In documents including personal information, a masking process of concealing a word or the like, which identifies an individual, by blackening or the like is often performed. Even in documents including content intended to be undisclosed other than personal information, a masking process of blackening or the like a portion related to the content intended to be undisclosed is often performed.

PTL 1 (JP 2007-122153 A) discloses a technique of masking a character string selected by a user's drag operation and displaying a document including the masked character string. PTL 2 (JP 2008-098948 A) discloses a technique of embedding control information in a text area designated by a user, and describes, a process of blackening text or an image designated by the user as an example of the control information. PTL 3 (JP 2008-017184 A) discloses a technique of identifying a text object written on an electronic blackboard as a masking target and performing a masking process on the text object in an electronic blackboard system.

### CITATION LIST

### Patent Literature

PTL 1: JP 2007-122153 A
PTL 2: JP 2008-098948 A
PTL 3: JP 2008-017184 A

### SUMMARY OF INVENTION

### Technical Problem

Here, a masking process of concealing personal information included in a document by blackening or the like is assumed to be necessary when disclosing a document described on a paper surface. In this case, for example, it is considered that an operator blackens (masks) the personal information on the paper surface by a manual work while visually confirming words or the like described in the document. However, in a case in which the document is long, it takes a lot of time to perform the masking process, and a situation in which masking omission occurs due to visual observation, that is, a situation in which a part required to be masked is not masked is likely to occur. Therefore, it is necessary to perform an operation of checking masking omission. For this reason, there is a problem that in a case in which the document is long, the masking process is inefficient and imposes a large burden on the worker.

In this regard, in order to improve the efficiency of the masking process, a technique of digitizing a document, extracting a word of a masking target from text data of the document by digitizing by using a search function of a computer, and masking the extracted word is considered. However, the word of the masking target may change depending on content of a document or a disclosure recipient (disclosure requester) to whom the document is disclosed. For this reason, it is necessary to change the word of the masking target extracted from the text data by the search function of the computer depending on the content of the document or the disclosure recipient. In order to implement a computer device that executes a masking process capable of coping with such a change in the word of the masking target, it is necessary to have a large amount of information related to the masking process according to the content of the document and the disclosure recipient. However, in practice, it is difficult to prepare a large amount of information related to the masking process in such a way that the masking process can be performed satisfactorily depending on various documents or disclosure recipients. It is considered difficult to implement a computer device capable of coping with the change in the document or the disclosure recipient and efficiently executing the masking process while suppressing an increase in device load.

The present invention has been made in light of the above problems. That is, it is a main object of the present invention to provide a technique capable of flexibly coping with the change in the word to be subjected to the masking process, and improving efficiency of the masking process to be performed on a document while suppressing an increase in device load.

### Solution to Problem

In order to achieve the above object, a document masking device according to the present invention includes, as an aspect thereof, an extraction unit that extracts a word belonging to a concealment target attribute representing a type of a word that is to undergo the masking process from text data of a document by using a natural language processing technology, a presentation unit that presents the extracted word as a masking candidate, and an output unit that outputs the document in which the masking process has been performed on a word of a masking target designated as the masking target from the masking candidate.

A document masking method according to the present invention is performed by a computer, and includes, as an aspect thereof, extracting a word belonging to a concealment target attribute representing a type of a word that is to undergo the masking process from text data of a document by using a natural language processing technology, presenting the extracted word as a masking candidate, and outputting the document in which the masking process has been performed on a word of a masking target designated as the masking target from the masking candidate.

A program storage medium according to the present invention stores a computer program causing a computer to execute, as an aspect thereof, a process of extracting a word belonging to a concealment target attribute representing a type of a word that is to undergo the masking process from text data of a document by using a natural language processing technology, a process of presenting the extracted word as a masking candidate, and a process of outputting the paper surface image in which the masking process has been performed on a word of a masking target designated as the masking target from the masking candidate.

### Advantageous Effects of Invention

According to the present invention, it is possible to flexibly cope with the change in the word to be subjected to the masking process, and it is possible to improve the efficiency of the masking process to be performed on the document while suppressing the increase in the device load.

### BRIEF DESCRIPTION OF DRAWINGS

FIG. 1 is a block diagram illustrating an example embodiment of a document masking device according to the present invention.

FIG. 2 is a diagram illustrating a display example in which masking candidates are displayed on a display device.

FIG. 3 is a diagram illustrating another display example in which masking candidates are displayed on the display device.

FIG. 4 is a view illustrating an example of a paper surface image that has undergone the masking process.

FIG. 5 is a diagram illustrating a modified example of functions of a presentation unit and an output unit.

FIG. 6 is a flowchart illustrating an example of an operation related to a masking process in a document masking device of a first example embodiment.

FIG. 7 is a diagram illustrating manual designation on a masking area.

FIG. 8 is a block diagram illustrating a modified example of a document masking device of a third example embodiment.

FIG. 9 is a block diagram illustrating other example embodiments of the document masking device according to the present invention.

FIG. 10 is a flowchart illustrating an example of another operation related to the masking process in the document masking device.

### EXAMPLE EMBODIMENT

Hereinafter, example embodiments according to the present invention will be described with reference to the drawings.

### First Example Embodiment

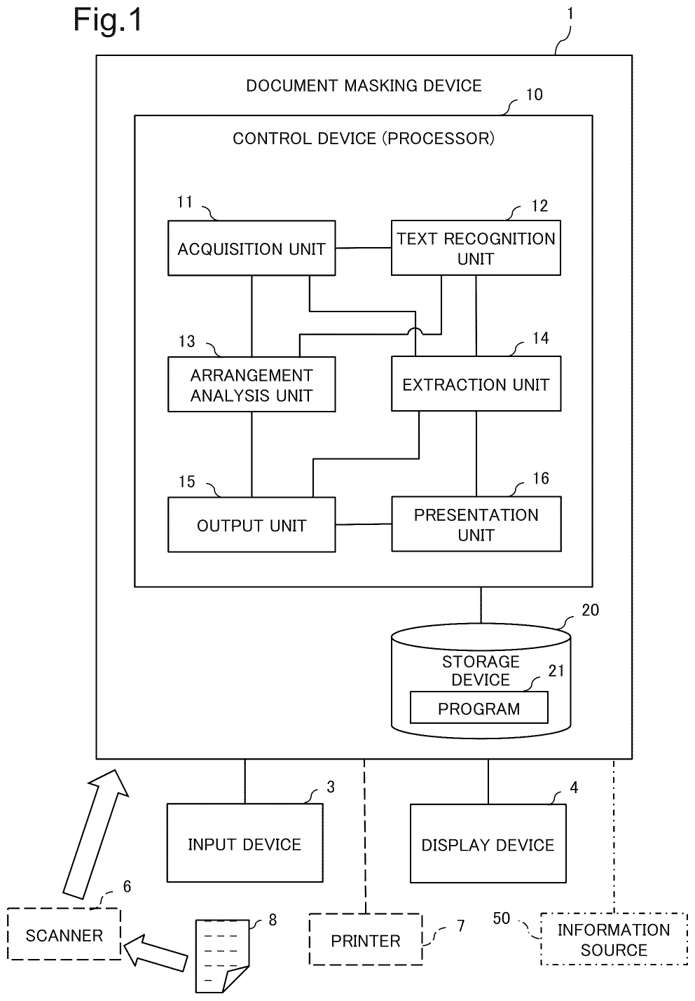

FIG. 1 is a diagram illustrating a configuration of a document masking device according to a first example embodiment of the present invention. A document masking device 1 of the first example embodiment has a function of acquiring an image of a paper surface 8 converted into image data by a scanner 6, performing a masking process on words of a masking target in a document shown on the acquired image of the paper surface 8, and outputting the image of the paper surface that has undergone to the masking process. Here, the image of the paper surface 8 converted into the image data is also referred to as a paper surface image. In the example of FIG. 1, data of the paper surface image may be transmitted from the scanner 6 to the document masking device 1 directly or via an information communication network, or may be supplied from the scanner 6 to the document masking device 1 by means of a portable storage medium. The words of the masking target are decided by the user, and specific examples thereof include, but not limited to, personal information identifying an individual and words indicating content (for example, methods of murder) which is considered inappropriate to be disclosed other than personal information.

The document masking device 1 of the first example embodiment is a computer device, and is connected to an input device 3 and a display device 4. The input device 3 is a device that inputs information to the document masking device 1, and includes a keyboard, a mouse, or the like. The display device 4 is a device that displays information on a screen.

The document masking device 1 includes a control device 10 and a storage device 20. The storage device 20 includes a storage medium that stores data or a computer program (hereinafter, also referred to as a “program”) 21. There are a plurality of types of storage devices such as a magnetic disk device and a semiconductor memory element, and there are a plurality of types of semiconductor memory elements such as a random access memory (RAM) and a read only memory (ROM). The type of the storage device 20 included in the document masking device 1 is not limited to one. The computer device is mostly provided with a plurality of types of storage devices. Here, the type or the number of storage devices 20 included in the document masking device 1 are not limited, and the description thereof will be omitted. In a case in which the document masking device 1 includes a plurality of types of storage devices, the storage devices are collectively referred to as a storage device 20.

The control device 10 is configured with a processor such as a central processing unit (CPU) or a graphics processing unit (GPU). The control device 10 can have various functions based on the program 21 by reading and executing the program 21 stored in the storage device 20. Here, the control device 10 includes an acquisition unit 11, a text recognition unit 12, an arrangement analysis unit 13, an extraction unit 14, an output unit 15, and a presentation unit 16 as functional units based on a program for executing the masking process of concealing the words of the masking target in a document.

The acquisition unit 11 acquires data of an image (paper surface image) of the paper surface 8 which is converted into image data by the scanner 6. The acquired data of the paper surface image is stored in the storage device 20 in a state of being associated with identification information identifying the data, acquisition date and time information, and the like.

There is a case in which text data representing a document described on the paper surface 8 is associated with the data of the paper surface image acquired by the acquisition unit 11. That is, the scanner 6 may have an optical character recognition (OCR) function using an OCR technology. The OCR function is a function of recognizing a text from an image by using the OCR technology and generating text data including a text code representing the recognized text. There is a case in which text data (hereinafter, also referred to as “paper surface text data”) including a text code of a text recognized from the paper surface image by the OCR function of the scanner 6 is acquired by the acquisition unit 11 in a state of being associated with the data of the paper surface image. Here, the text refers to one to which a standardized text code such as a Unicode is assigned, and includes not only text such as kana characters, Chinese characters, and alphabetical characters but also mathematical symbols.

On the other hand, there is also a case in which the acquisition unit 11 acquires the data of the paper surface image with which the paper surface text data is not associated. In this case, the text recognition unit 12 recognizes the text of the document described on the paper surface 8 from the paper surface image acquired by the acquisition unit 11 by using the OCR technology, and generates text data (paper surface text data) including a text code of the recognized text. The paper surface text data is stored in the storage device 20 in association with the data of the paper surface image in which the text is recognized.

The extraction unit 14 analyzes the paper surface text data associated with the data of the paper surface image, and extracts, as masking candidates, words belonging to the following concealment target attributes from the paper text data. The concealment target attribute refers to an attribute indicating a type of word of the masking target which is to undergo the masking process.

Here, before the word of the masking target is specified, the word belonging to the concealment target attribute is extracted as the masking candidate from the paper surface text data by the extraction unit 14. The concealment target attribute is decided depending on the word which is to undergo the masking process (in other words, the content of the document which is to undergo the masking process), and includes, but not limited to, a name, a place, a date, a company name, an occupation, a gender, a title, a telephone number, and the like when masking personal information as specific examples.

In the first example embodiment, the extraction unit 14 extracts the word belonging to the concealment target attribute from the paper surface text data using a so-called artificial intelligence (AI) technology. In this case, a model of the AI technology (hereinafter, also referred to as “extraction model”) is stored in the storage device 20 in advance. The extraction model is a model that has the paper surface text data as an input and the word of the concealment target attribute extracted from the paper surface text data as an output, and is generated by performing machine learning on the words belonging to the concealment target attribute. For example, bidirectional encoder representations from transformers (BERT) which is a natural language processing technology is used in this extraction model.

As described above, the extraction unit 14 extracts the word belonging to the concealment target attribute as the masking candidate instead of extracting a specific word of the masking target, it is possible to suppress the masking omission problem caused by an OCR recognition error. It is assumed that the text having the name “Aoyama” is recognized as “Otoyama” due to an OCR recognition error (a situation in which a text recognized by the OCR function is wrong). In this case, it is assumed that “Aoyama” is extracted as the word of the masking target from the paper surface text data, and the extracted word is masked. In this case, “Aoyama” recognized as “Otoyama” due to the OCR recognition error is not extracted from the paper surface text data and is not masked. That is, the masking omission caused by the OCR recognition error occurs.

On the other hand, in the first example embodiment, the extraction unit 14 extracts not only “Aoyama” but also “Otoyama” occurring due to the OCR recognition error as the word (masking candidate) belonging to the name that is the concealment target attribute in accordance with determination from the context, for example, by using the natural language processing technology. Then, the masking process is performed on both “Aoyama” and “Otoyama”, thereby preventing the masking omission caused by the OCR recognition error.

The arrangement analysis unit 13 detects an arrangement position indicating where the text recognized by the OCR function of the scanner 6 or the text recognition unit 12 is located in the paper surface image, and the width of an occupied area occupied by the text. Then, the arrangement analysis unit 13 generates text position data indicating the arrangement position of each detected text in the paper surface image and the width of the occupied area. That is, in the first example embodiment, in order for the extraction unit 14 to analyze the paper surface text data in a state of being separated from the paper surface image, the word extracted by the extraction unit 14 from the paper surface text data is not associated with the arrangement position of the word in the paper surface image and the information of the width of the area occupied by the word. Therefore, in order to perform the masking process on the word extracted by the extraction unit 14 in the paper surface image, it is necessary to acquire information on the position of the word in the paper surface image and the width of the occupied area of the word. In consideration of this, the arrangement analysis unit 13 generates the text position data indicating the arrangement position of each text in the paper surface image and the width of the occupied area. An aspect of the character position data is not limited as long as the text position data can indicate the position of the text and the size of the occupied area in the paper surface image, and examples thereof include an aspect in which the position of the text and the width of the occupied area are indicated by using coordinates of a two-dimensional orthogonal coordinate system set in the paper surface image.

The presentation unit 16 causes the display device 4 to display the word of the masking candidate extracted by the extraction unit 14. The presentation unit 16 causes the display device 4 to display a message for prompting the user to designate (select) the words of the masking target to be masked from among the masking candidates displayed on the display device 4. The presentation unit 16 may cause a speaker included in a computer device constituting the document masking device 1 to notify the user of a message for prompting the user to designate the words of the masking target by voice.

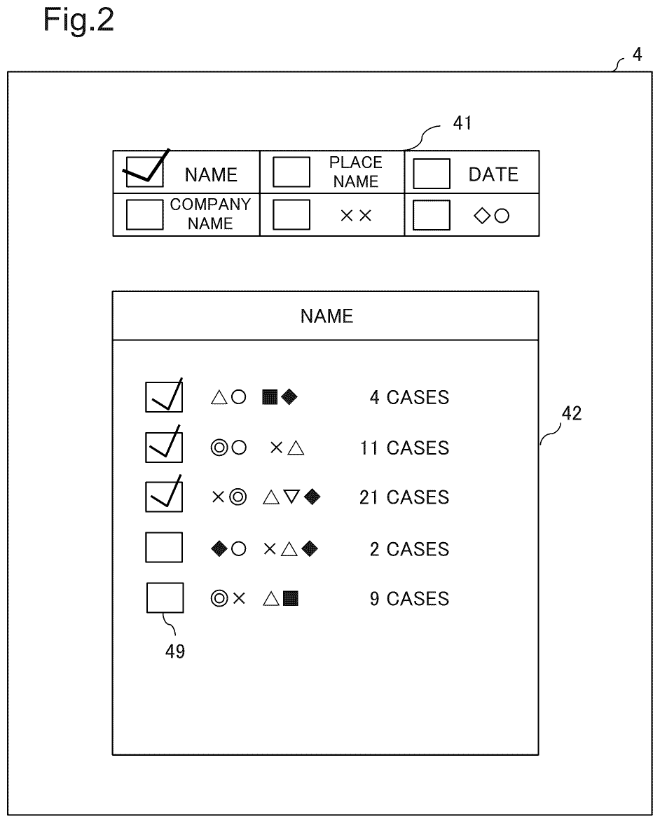

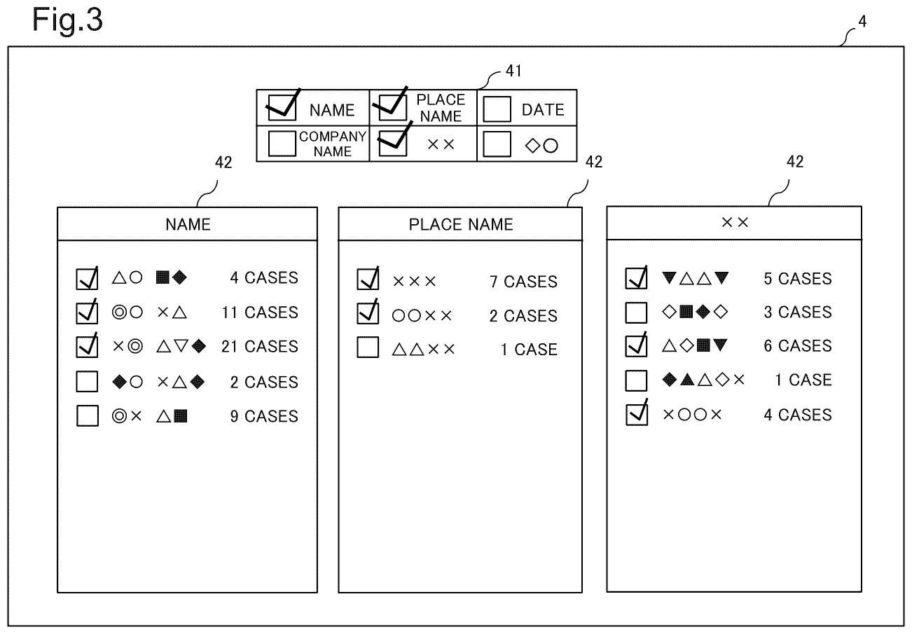

FIG. 2 illustrates a display example of the masking candidates displayed on the display device 4 by the presentation unit 16. Although all the words of the masking candidate extracted by the extraction unit 14 may be displayed in a list form, in the example of FIG. 2, the words of the masking candidate are displayed for each concealment target attribute. That is, a display attribute selection field 41 is displayed on the display screen of the display device 4. The display attribute selection field 41 is a field for displaying a name or the like representing the concealment target attribute as a choice in such a way as to select the concealment target attribute for displaying the word of the masking candidate. A masking candidate display field 42 is displayed on the display screen of the display device 4. The masking candidate display field 42 is a field for displaying the word of the masking candidates belonging to the concealment target attribute selected in the display attribute selection field 41. The word of the masking candidate displayed in the masking candidate display field 42 is a choice in which the user selects the word of the masking target by an operation of the input device 3, and a check mark indicating that the word has been selected as the word of the masking target can be displayed. Display control of the display attribute selection field 41 and the masking candidate display field 42 is executed by the presentation unit 16 by using information of a display format given in advance or information input by the user operating the input device 3. In a case in which a plurality of concealment target attributes are selected in the display attribute selection field 41, the presentation unit 16 displays the masking candidate display field 42 associated with each of the plurality of selected concealment target attributes on the same screen as illustrated in FIG. 3. Alternatively, the presentation unit 16 may cause the display device 4 to display the masking candidate display field 42 associated with each of the plurality of selected concealment target attributes one by one in response to a display request from the user by the operation of the input device 3.

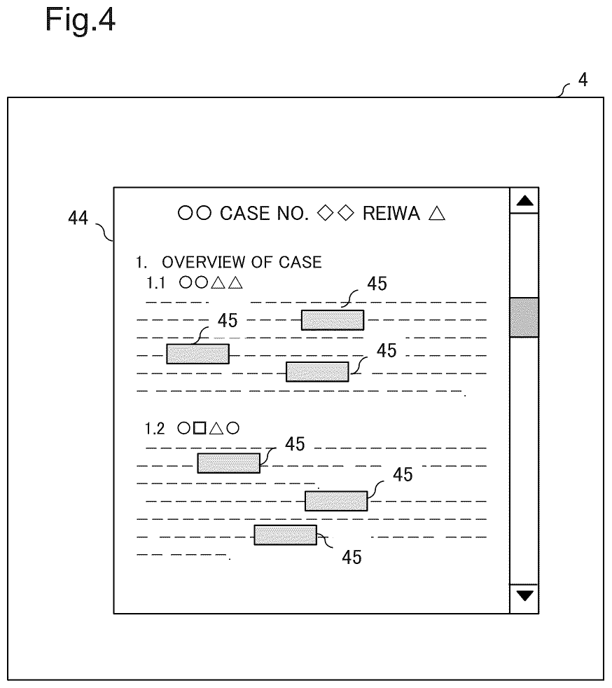

The output unit 15 specifies the position of the word of the masking target in the paper surface image and the width of the occupied area occupied by the word by using the information indicating the word selected as the masking target and the text position data generated by the arrangement analysis unit 13. That is, the output unit 15 specifies a masking area in the paper surface image. Then, the output unit 15 executes, on the paper surface image, the masking process of masking the text in the masking area in the paper surface image, and outputs the paper surface image that has undergone the masking process to the display device 4. As a result, as illustrated in FIG. 4, the output unit 15 causes the display device 4 to display the masked paper surface image in which texts in masking areas 45 in a paper surface image 44 are masked. The output unit 15 may cause the printer 7 to print out the masked paper surface image by outputting the masked paper surface image to the printer 7. As long as the text can be concealed by a technique of masking the text in the masking area, the text in the masking area may be masked by blackening the masking area, or the text in the masking area may be masked by, for example, a fine mesh pattern.

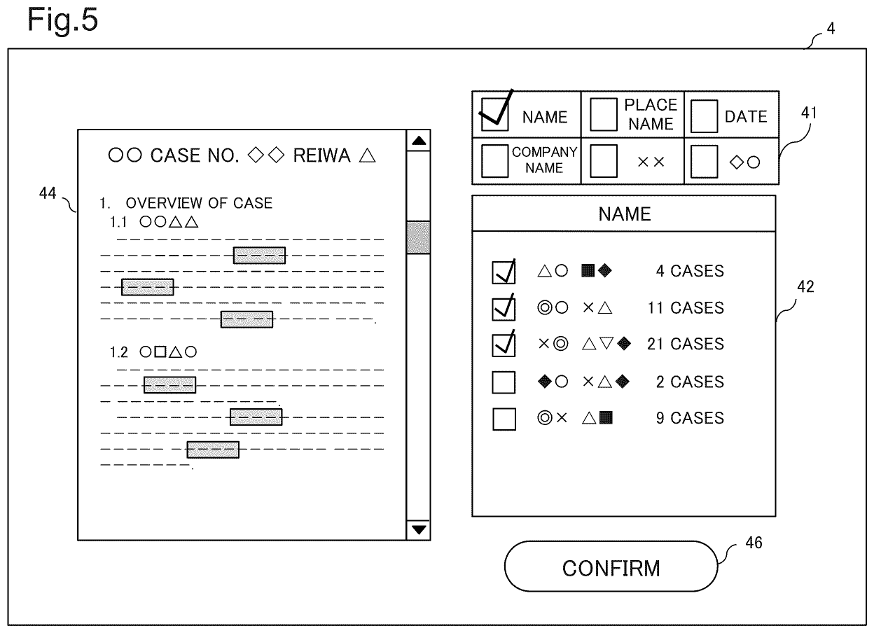

FIG. 5 is a diagram illustrating a modified example of the presentation unit 16 and the output unit 15. In the example of FIG. 5, the display attribute selection field 41 and the masking candidate display field 42 by the presentation unit 16, and the paper surface image 44 by the output unit 15 are displayed side by side on the same screen on the display device 4. As a result, the user can confirm, on the single screen, the words selected as the masking target in the masking candidate display field 42 and the paper surface image 44 in which the selected words of the masking target are masked. In this case, first, before masking the words in the masking areas, the output unit 15 notifies the user of the words of the masking target by clearly indicating the words in the masking areas with highlight display or a conspicuous background color.

Then, when the user confirms the text of the masking target and then inputs “confirm” on the texts of the masking target by using the input device 3, for example, by using an icon 46, the output unit 15 masks the words of the masking target. The words of the masking target in the paper surface image may be masked by the presentation unit 16 and the output unit 15 according to this modified example.

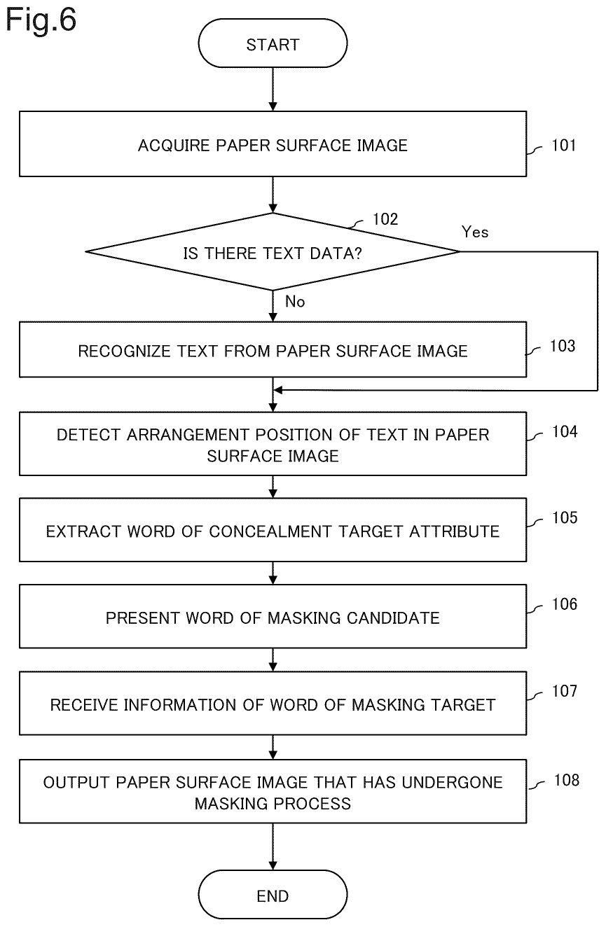

Next, an example of an operation related to the masking process in the document masking device 1 will be described with reference to FIG. 6. FIG. 6 is a flowchart illustrating an example of an operation related to the masking process in the document masking device 1.

In the document masking device 1, first, when the acquisition unit 11 acquires data of the paper surface image from the scanner 6 (step 101 in FIG. 6), the following determination operation is executed. That is, it is determined whether text data (paper surface text data) of a document included in the paper surface image is associated with the acquired paper surface image (step 102). Then, in a case in which the paper surface text data is not associated with the paper surface image, the text recognition unit 12 recognizes a text from the paper surface image (step 103), and generates paper surface text data including a text code of the recognized text.

Subsequently, the arrangement analysis unit 13 detects arrangement of the text in the paper surface image (step 104) and generates text position data.

On the other hand, the extraction unit 14 extracts words belonging to the concealment target attribute from the paper surface text data using the extraction model (step 105). Then, the presentation unit 16 presents the words extracted by the extraction unit 14 to the user by causing the words to be displayed on the display device 4 as the words of the masking candidate (step 106).

The output unit 15 receives information of the words of the masking target selected by the user who has viewed the display (step 107). As a result, the output unit 15 detects the positions of the words of the masking target in the paper surface image and the width of the area occupied by the word (masking area) by using the information of the word of the masking target and the text position data generated by the arrangement analysis unit 13. Then, the output unit 15 executes, on the paper surface image, the masking process of masking the text in the masking area in the paper surface image, and outputs the paper surface image that has undergone the masking process to the display device 4 or the printer 7 (step 108).

The document masking device 1 of the first example embodiment first extracts the words having the concealment target attribute including the words of the masking target as the masking candidate by using the natural language processing technology, instead of extracting only the words of the masking target from the paper surface text data. As a result, even if the OCR recognition error occurs for the words of the masking target, the words are extracted from the paper surface text data as the words of the concealment target attribute. Therefore, the document masking device 1 can suppress the problem that the words of the masking target are not extracted from the paper surface text data due to the OCR recognition error.

There is a case in which the words of the concealment target attribute extracted from the paper surface text data include a word that is not the masking target. In this regard, the document masking device 1 of the first example embodiment extracts the words of the concealment target attribute from the paper surface text data as the masking candidate, presents the words of the masking candidate to the user, and causes the user to select the words of the masking target from the words of the masking candidate. Thus, the document masking device 1 can perform processing in such a way that the masking process is not executed on a word that needs not to be masked even if the word has the concealment target attribute.

In addition, the document masking device 1 of the first example embodiment extracts the words of the concealment target attribute as the masking candidate, presents the words of the masking candidate to the user, and causes the user to select the words of the masking target from the words of the masking candidate. Therefore, in the document masking device 1, since the user selects the words of the masking target and inputs the information, it is not necessary to hold the information of the word itself of the masking target. As a result, even if the words of the masking target change due to the content of the document which is to undergo the masking process or the like, the document masking device 1 can flexibly cope with the change, and can improve the efficiency of the masking process to be performed on the document while suppressing an increase in load.

The document masking device 1 analyzes the paper surface text data and extracts the words of the concealment target attribute from the paper surface text data, and thus the information of the arrangement position in the paper surface image and the width of the occupied area is not associated with the extracted word. Therefore, the document masking device 1 has a function of associating the word extracted from the paper surface text data with the information of the arrangement position of the word in the paper surface image and the width of the occupied area. That is, the document masking device 1 has a function of generating, by the arrangement analysis unit 13, the text position data indicating the arrangement position of the text in the paper surface image and the width of the occupied area. In addition, the document masking device 1 has a function of detecting the arrangement position of the word extracted by the extraction unit 14 in the paper surface image and the width of the occupied area occupied by the word with reference to the text position data by the output unit 15. With this function, the document masking device 1 can execute the masking process on the words of the masking target in the paper surface image.

In addition, as described above, even if an OCR recognition error occurs for the word of the masking target, the word of the masking target is highly likely to be extracted from the paper surface text data as the word of the concealment target attribute. Thus, the document masking device 1 can suppress the extraction omission of the word of the masking target which is caused due to the OCR recognition error. Therefore, the document masking device 1 can reduce an operator's burden of checking whether the masking process is correctly executed on the paper surface image, and can improve the efficiency of the masking process.

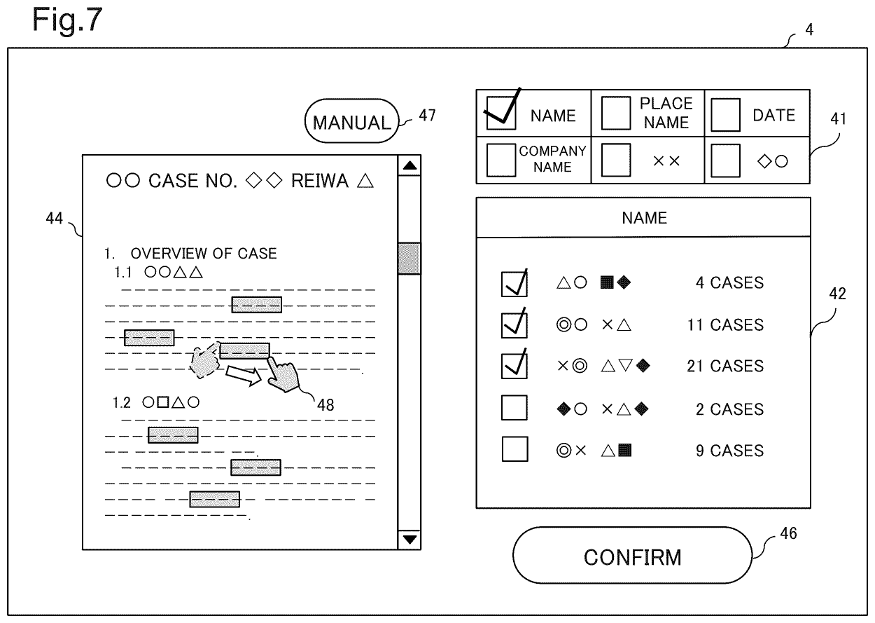

The document masking device 1 of the first example embodiment may have a function of executing a manual mode of the masking process in addition to the above-described functions. For example, in a case in which the user inputs a command to execute the manual mode of the masking process by operating the input device 3 by using an icon 47 as illustrated in FIG. 7, the document masking device 1 starts the operation in the manual mode. In the manual mode, when the user designates the areas of the masking target in the paper surface image by operating the input device 3 by a cursor 48 or the like as illustrated in FIG. 7, for example, the designated areas are masked. Since the operation in the manual mode described above can be performed, the document masking device 1 can mask not only the text but also the areas including no text (text data) such as a drawing or a photograph in the paper surface image. Accordingly, the document masking device 1 can more flexibly respond to the user's request.

### Second Example Embodiment

Hereinafter, a second example embodiment according to the present invention will be described. In the description of the second example embodiment, the same reference numerals are given to the same name parts as the components constituting the document masking device of the first example embodiment, and redundant description of the common parts will be omitted.

A document masking device 1 of the second example embodiment is connected to an information source 50 indicated by a dotted line in FIG. 1, for example, via an information communication network, and acquires reference information related to the masking process from the information source 50. The reference information includes at least information indicating the word of the masking target. The reference information is used by the presentation unit 16. That is, in the second example embodiment, the presentation unit 16 extracts information representing the word of the masking target from the reference information. In a case in which the word of the masking candidate is displayed on the display device 4, the presentation unit 16 displays the word of the masking candidate in a state in which information indicating that the word of the masking candidate is the word of the masking target is associated with the word of the masking candidate associated with the word of the masking target extracted from the reference information. For example, in the display example of the masking candidate display field 42 illustrated in FIG. 2 and the like, check fields 49 associated with the words of the masking candidate on a one-to-one basis are displayed. The presentation unit 16 displays in advance a check indicating that the word is the word of the masking target in the check field 49 of the word of the masking candidate associated with the word of the masking target acquired from the reference information. Of course, the user can cancel the check displayed by the presentation unit 16 by operating the input device 3.

The components of the document masking device 1 according to the second example embodiment which are not described above are similar to the components of the document masking device 1 according to the first example embodiment.

In a case in which the presentation unit 16 presents that the word is the masking candidate, the document masking device 1 of the second example embodiment sets a state in which information indicating that the word is the masking target is associated with the word of the masking candidate associated with the word of the masking target obtained from the reference information acquired from the information source 50. Thus, the document masking device 1 of the second example embodiment can reduce the burden and improve the efficiency when the user selects the word of the masking target.

### Third Example Embodiment

Hereinafter, a third example embodiment according to the present invention will be described. In the description of the third example embodiment, the same reference numerals are given to the same name parts as the components constituting the document masking device of the first or second example embodiment, and redundant description of the common parts will be omitted.

A document masking device 1 of the third example embodiment has, in addition to the functions of the document masking device of the first or second example embodiment, a function of executing the masking process on a document generated by an application with a text input function. Here, the application with a text input function is not limited to an application that mainly generates documents, and includes, for example, an application that mainly performs table calculation and further has a text input function.

In the document masking device 1 of the third example embodiment, the acquisition unit 11 can acquire not only data of the paper surface image but also data (hereinafter, also referred to as “document data”) of the document generated by the application with the text input function. The acquired document data is stored in the storage device 20 in a state in which the data is associated with identification information identifying the data, acquisition date and time information, and the like.

The extraction unit 14 extracts text data included in the document data, and extracts, as the masking candidates, words belonging to the concealment target attribute from the extracted text data, similarly to the first and second example embodiments.

The presentation unit 16 causes the display device 4 to display the word of the masking candidate extracted by the extraction unit 14, similarly to the first and second example embodiments.

The output unit 15 specifies the word of the masking target in the text data included in the document data by using the information indicating the word selected as the masking target. Then, the output unit 15 executes the masking process of masking the word of the masking target in the document data, and outputs the document that has undergone the masking process to the display device 4 or the printer 7. The masking process herein is not limited as long as the word of the masking target in the text data of the document can be concealed, and for example, a text representing the word of the masking target may be replaced with a symbol.

The components of the document masking device 1 of the third example embodiment which are not described above are similar to those of the first or second example embodiment.

Since the document masking device 1 of the third example embodiment has a configuration (functions) similar to those of the first and second example embodiments, similar effects to those of the first and second example embodiments can be obtained. Further, the document masking device 1 of the third example embodiment can perform the masking process on not only the paper surface image but also the document generated by the application with the text input function and output the resulting document.

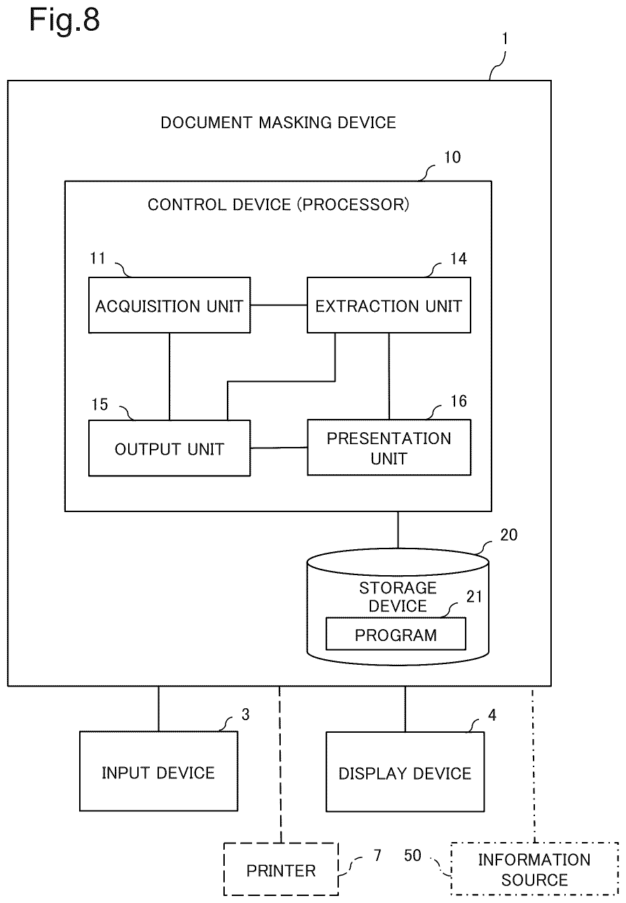

The document masking device 1 of the third example embodiment has the function of performing the masking process on a document generated by an application in addition to the functions of the document masking device of the first example embodiment or the second example embodiment. Alternatively, the document masking device 1 may be a device that performs the masking process only on the document generated by the application with the text input function without considering the masking process on the paper surface image. In this case, as illustrated in FIG. 8, in the document masking device 1, the functions of the text recognition unit 12 and the arrangement analysis unit 13 described in the first and second example embodiments can be omitted.

### Other Example Embodiments

The present invention is not limited to the first to third example embodiments, and various embodiments can be adopted. For example, in the first and second example embodiments, the paper surface image acquired by the acquisition unit 11 of the document masking device 1 is an image representing the paper surface 8 converted into the image data by the scanner 6, but for example, the paper surface image may be obtained by converting a document, which is created by an application that generates a document, into image data.

In the second example embodiment, the document masking device 1 is connected to the information source 50 via the information communication network, and the reference information including the information indicating the word of the masking target is provided from the information source 50 to the document masking device 1 via the information communication network. Alternatively, the reference information including the information indicating the word of the masking target may be input to the document masking device 1 by the user. In this case, by using the reference information input by the user, the presentation unit 16 displays the word of the masking candidate in a state in which the word of the masking candidate associated with the word of the masking target extracted from the reference information is associated with the information indicating that the word of the masking candidate is the word of the masking target.

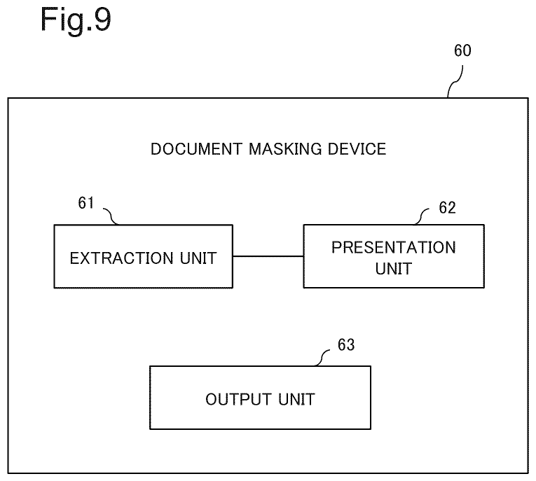

FIG. 9 is a block diagram illustrating a configuration of a document masking device according to another example embodiment of the present invention. A document masking device 60 illustrated in FIG. 9 is, for example, a computer device, and includes an extraction unit 61, a presentation unit 62, and an output unit 63 which are functional units based on a computer program. The extraction unit 61 extracts the word belonging to the concealment target attribute indicating a type of word that is to undergo the masking process from the text data of the document by using the natural language processing technology. The presentation unit 62 presents the extracted words as the masking candidate. The output unit 63 outputs a document in which the masking process has been performed on the words of the masking target which are designated as the masking target from the masking candidates.

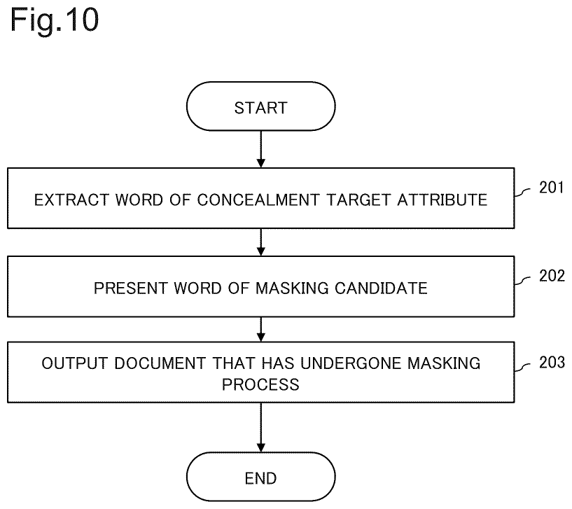

Next, an example of an operation related to the masking process in the document masking device illustrated in FIG. 9 will be described with reference to FIG. 10.

For example, first, the extraction unit 61 extracts the word belonging to the concealment target attribute indicating the type of word that is to undergo the masking process from the text data of the document by using the natural language processing technology (step 201 in FIG. 10). Then, the presentation unit 62 presents the extracted word as the masking candidate, for example, by displaying the word on the display device (step 202).

Subsequently, the output unit 63 performs the masking process on the word of the masking target designated as the masking target from the masking candidate, and outputs the document that has undergone the masking process (step 203).

Since the document masking device 60 that executes the functions and operations described above extracts the words of the masking candidate from text data of the document by using the natural language processing technology, the efficiency of the masking process can be improved as compared with the case in which the words are visually extracted. The document masking device 60 extracts the words of the concealment target attribute as the masking candidate, presents the words of the masking candidate to the user, and causes the user to select the words of the masking target from the words of the masking candidate. Therefore, in the document masking device 60, since the user selects the words of the masking target and inputs the information, it is not necessary to hold the information of the word itself of the masking target. As a result, even if the words of the masking target change due to the content of the document which is to undergo the masking process or the like, the document masking device 60 can flexibly cope with the change, and can improve the efficiency of the masking process to be performed on the document while suppressing an increase in load.

The present invention has been described above using the above-described example embodiments as exemplary examples. However, the present invention is not limited to the above-described example embodiments. That is, the present invention can apply various aspects that can be understood by those skilled in the art within the scope of the present invention.

This application is based upon and claims the benefit of priority from Japanese patent application No. 2021-176073, filed on Oct. 28, 2021, the disclosure of which is incorporated herein in its entirety by reference.

### REFERENCE SIGNS LIST

1, 60 document masking device
12 text recognition unit
13 arrangement analysis unit
14, 61 extraction unit
15, 63 output unit
16, 62 presentation unit

What is claimed is:

1. A document masking device, comprising:
a memory configured to store instructions; and
at least one processor configured to execute the instructions to:
extract a word belonging to a concealment target attribute representing a type of a word that is to undergo a masking process from text data of a document by using a natural language processing technology;
present the extracted word as a masking candidate; and
output the document in which the masking process has been performed on a word of a masking target designated as the masking target from the masking candidate.

2. The document masking device according to claim 1, wherein the at least one processor is configured to use a model, the model is generated by performing machine learning on the word belonging to the concealment target attribute and outputs the word belonging to the concealment target attribute included in text data of the document by using the text data of the document as an input.

3. The document masking device according to claim 1, wherein the document masking device is connected to an information source that outputs reference information including information indicating a word that is to undergo the masking process,
wherein the at least one processor is further configured to extract information of a word of a masking target that is to undergo a masking process from the reference information, and perform a presentation in a state in which information indicating that the word is the word of the masking target is associated with the masking candidate associated with the word of the masking target based on the extracted information.

4. The document masking device according to claim 1, wherein the document is a document included in a paper surface image representing a paper surface converted into an image,
wherein the at least one processor is further configured to acquire, from the paper surface image, information of an arrangement position of a text represented by the text data in the paper surface image and a width of an occupied area in the paper surface image with respect to the text represented by the text data;
specify a masking area of the paper surface image in which the word of the masking target designated as the masking target from the masking candidate is masked by using the information of the arrangement position of the text and the width of the occupied area acquired from the paper surface image; and
output the paper surface image including the document in which the masking process has been performed on the masking area.

5. The document masking device according to claim 4, wherein the at least one processor is further configured to extract the text data of the document included in the paper surface image from the paper surface image by an optical character recognition technology.

6. A document masking method performed by a computer, comprising:
extracting a word belonging to a concealment target attribute representing a type of a word that is to undergo a masking process from text data of a document by using a natural language processing technology;
presenting the extracted word as a masking candidate; and
outputting the document in which the masking process has been performed on a word of a masking target designated as the masking target from the masking candidate.

7. A non-transitory program storage medium storing a computer program causing a computer to execute:
extracting a word belonging to a concealment target attribute representing a type of a word that is to undergo a masking process from text data of a document by using a natural language processing technology;
presenting the extracted word as a masking candidate; and
outputting the document in which the masking process has been performed on a word of a masking target designated as the masking target from the masking candidate.
